(19) United States
(12) Patent Application Publication
(10) Pub. No.: US 2022/0159502 A1
(43) Pub. Date: May 19, 2022

(54) Method, Apparatus for Synchronization of Status of QoS Flow in Communication System

(71) Applicant: Telefonaktiebolaget LM Ericsson (publ), Stockholm (SE)

(72) Inventors: Juying Gan, Shanghai (CN); Qian Chen, Mölndal (SE); Peter Hedman, Helsingborg (SE); Mikael Wass, Sätila (SE); Stefan Rommer, Västra Frölunda (SE)

(21) Appl. No.: 17/440,233

(22) PCT Filed: Jun. 28, 2019
(86) PCT No.: PCT/CN2019/093797

§ 371 Date: Sep. 17, 2021

(30) Foreign Application Priority Data
Mar. 29, 2019 (CN) PCT/CN2019/080612

(51) Int. Cl. H04W 28/02; H04W 76/32

(52) U.S. Cl. CPC H04W 28/0268; H04W 76/32

(57) ABSTRACT

The present disclosure relates to a method, an apparatus for a synchronization of a status of a QoS flow in a communication system. A method is performed at a terminal device, for a synchronization of a status of a quality of service, QoS, flow in a communication system. The method comprises: deleting (S101) the QoS flow locally; marking (S102) a status of the QoS flow as being deleted and not synchronized; and transmitting (S103) a protocol data unit, PDU, session modification request to synchronize the status of the QoS flow. According to embodiments of the present disclosure, when the status of the QoS Flow is changed by one of the terminal device or the network side in some scenarios, the status of the QoS Flow can still be synchronized.

### TECHNICAL FIELD

The present disclosure relates generally to the technology of communication, and in particular, to a method, an apparatus for a synchronization of a status of a QoS flow in a communication system.

### BACKGROUND

This section introduces aspects that may facilitate better understanding of the disclosure. Accordingly, the statements of this section are to be read in this light and are not to be understood as admissions about what is in the prior art or what is not in the prior art.

In a 5th generation system (5GS), a mechanism of quality of service, QoS, flow is established for providing manner to management of the QoS level, such as bit rate, of a communication between a terminal device and the network side.

When a QoS flow is used for the communication, the terminal device and the network side will both store the status of the QoS flow. The status of the QoS flow should be synchronized, namely, when any one of the terminal device or the network side changes the status of the QoS flow, other one should be notified. For example, a 3rd generation partnership project technical specification, 3GPP TS, 23.502 v15.5.0 has specified that “The SMF may decide to modify PDU Session . . . It may also be triggered if . . . the SMF has marked that the status of one or more QoS Flows are deleted in the 5GC but not synchronized with the UE yet” SMF refers to system management function. PDU refers to protocol data unit. 5GC refers to 5th generation core. UE refers to user equipment.

However, as the development of the communication system, there are some scenarios, in which the status of the QoS Flow might be changed by one of the terminal device or the network side, and cannot be synchronized yet.

### SUMMARY

Certain aspects of the present disclosure and their embodiments may provide a solution to at least part of these or other challenges. There are, proposed herein, various embodiments which address one or more of the issues disclosed herein.

A first aspect of the present disclosure provides a method, performed at a terminal device, for a synchronization of a status of a quality of service, QoS, flow in a communication system. The method comprises: deleting the QoS flow locally; marking a status of the QoS flow as being deleted and not synchronized; and transmitting a protocol data unit, PDU, session modification request to synchronize the status of the QoS flow.

In embodiments of the present disclosure, the QoS flow is deleted due to a deletion of a dedicated evolved packet system, EPS, bearer. The QoS flow is mapped from the dedicated EPS bearer when preparing for an interworking procedure of the terminal device from an EPS to a 5th generation system, 5GS. The PDU session modification request includes: a request to clean up the QoS flow.

In embodiments of the present disclosure, the PDU session modification request is transmitted when the terminal device changes from a CM-IDLE status to a CM-CONNECTED status, wherein CM refers to connection management.

In embodiments of the present disclosure, the QoS flow is a QoS flow not associated to a default QoS rule.

In embodiments of the present disclosure, the QoS flow is deleted when the terminal device is in a 5GS. The PDU session modification request includes: a request to clean up the QoS flow.

In embodiments of the present disclosure, the QoS flow is a QoS flow not associated to a default QoS rule.

A second aspect of the present disclosure provides a method, performed at a network node, for a synchronization of a status of a bearer in a communication system, the method comprising: obtaining a status of an EPS bearer, based on an EPS bearer identify, EBI, list; transmitting the status of the EPS bearer to a terminal device.

In embodiments of the present disclosure, the EPS bearer comprises: a default EPS bearer or a dedicated EPS bearer. The status of the EPS bearer is transmitted in a register accept message during an interworking procedure of the terminal device from an EPS to a 5GS.

In embodiments of the present disclosure, the method further comprises: obtaining the EBI list from one or more system management functions, SMFs.

In embodiments of the present disclosure, the status of the EPS bearer is related to whether being active, or inactive.

In embodiments of the present disclosure, a deletion of the EPS bearer is initiated by a mobility management entity, MME, or packet data network gateway, PGW, and not synchronized with the terminal device.

In embodiments of the present disclosure, the network node is an access and mobility management function, AMF.

A third aspect of the present disclosure provides method, performed at a terminal device, for a synchronization of a status of a bearer in a communication system, the method comprising: receiving a register accept message during an interworking procedure of the terminal device from an EPS to a 5GS; obtaining a status of an EPS bearer, based on the register accept message. The status of the EPS bearer is included in the register accept message by a network node, based on an EPS bearer identify, EBI, list.

In embodiments of the present disclosure, the status of the EPS bearer is related to whether being active or inactive.

A fourth aspect of the present disclosure provides a terminal device, comprising: a processor; and a memory, containing instructions executable by the processor. The terminal device is operative to: delete a quality of service, QoS, flow locally; mark a status of the QoS flow as being deleted and not synchronized; and transmit a protocol data unit, PDU, session modification request to synchronize the status of the QoS, flow.

In embodiments of the present disclosure, the terminal device is operative to any of the methods above mentioned.

A fifth aspect of the present disclosure provides network node, comprising: a processor; and a memory, containing instructions executable by the processor. The network node is operative to: obtain a status of an EPS bearer, based on an EPS bearer identify, EBI, list; transmit the status of the EPS bearer to a terminal device.

In embodiments of the present disclosure, the network node is operative to any of the methods above mentioned.

A sixth aspect of the present disclosure provides terminal device, comprising: a processor; and a memory, containing instructions executable by the processor. The terminal device is operative to: receive a register accept message during an interworking procedure of the terminal device from an EPS to a 5GS; obtain a status of an EPS bearer, based on the register accept message. The status of the EPS bearer is included in the register accept message by a network node, based on an EPS bearer identify, EBI, list.

In embodiments of the present disclosure, the terminal device is operative to any of the methods above mentioned.

A seventh aspect of the present disclosure provides computer readable storage medium having a computer program stored thereon, wherein the computer program is executable by a device to cause the device to carry out any of the methods above mentioned.

According to embodiments of the present disclosure, when the status of the QoS Flow is changed by one of the terminal device or the network side in some scenarios, the status of the QoS Flow can still be synchronized.

### BRIEF DESCRIPTION OF DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 is an exemplary flow chart showing a method according to embodiments of the present disclosure;

FIG. 2 is an exemplary flow chart showing substeps of the method in FIG. 1 according to embodiments of the present disclosure;

FIG. 3 is an exemplary flow chart showing other methods according to embodiments of the present disclosure;

FIG. 4 is an exemplary diagram showing an implementation of methods shown in FIG. 3 in a communication system;

FIG. 5 is a block schematic showing an exemplary terminal device according to embodiments of the present disclosure;

FIG. 6 is a block schematic showing an exemplary network node according to embodiments of the present disclosure; and

FIG. 7 is schematic showing computer readable storage medium in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network/system” refers to a network/system following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” or “network side node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth. The network node may also comprises: AMF, MME, PGW, etc.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As examples, some scenarios and embodiments will be introduced. These scenarios will be described as exemplary circumstance for implement of embodiments of the present disclosure, without limitation.

As the development of the communication technology, one integrated communication network may include different parts/structures/systems, such as evolved packet system, EPS, 5th generation system, 5GS.

A terminal device may move/switch from one system to another, due to changes of usage circumstances, such as physical location, or serves requirement. During an exemplary movement from the EPS to the 5GS while remaining a communication session between the terminal device and the network side, a QoS flow may be establish in the 5GS and mapped from an EPS bearer in the EPS.

However, during such movement, one of the terminal device and the network side might delete a QoS flow or an EPS bearer corresponding to a QoS flow, and not notify the other one, thus, unsynchronization of the status of QoS flow might happen.

As a first specific embodiment, a terminal device, such as a UE, stays in IDLE state in EPS, and then moves to 5GS. The UE may locally delete a dedicated EPS bearer in the EPS, and not notify the network side. Therefore, after a PDU session between the UE and the network is established in 5GS, the network has the QoS Flow(s) associated to the deleted dedicated EPS bearer. This QoS Flow(s) is unsynchronized. When the communication between the UE and the network side starts in 5GS, downlink, DL, packet will be able to be sent from the network side to the UE on the unsynchronized QoS Flow. Uplink, UL, packet will probably be sent via other synched QoS flow, such as a QoS Flow associated with a default QoS rule.

In such a scenario, the possible issue is that differentiation of UL packet forwarding treatment cannot be achieved (assume the UE does not drop the DL packet received from the network on the unsynchronized QoS Flow), or the UE will just drop the DL packet received on the unsynchronized QoS Flow.

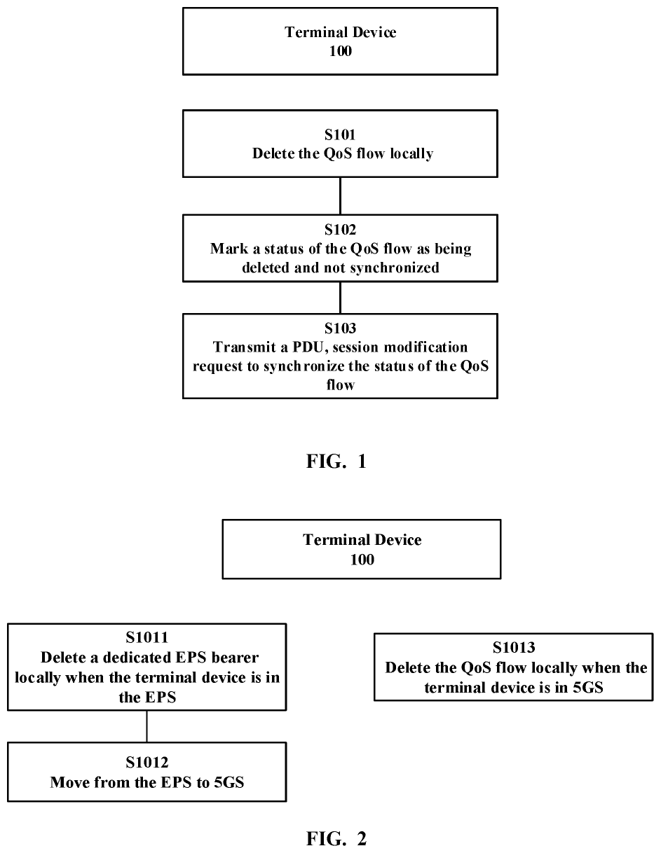

FIG. 1 is an exemplary flow chart showing a method according to embodiments of the present disclosure; and FIG. 2 is an exemplary flow chart showing substeps of the method in FIG. 1 according to embodiments of the present disclosure.

As shown in FIG. 1, the method is performed at a terminal device 100, for a synchronization of a status of a quality of service, QoS, flow in a communication system. The method comprises: S101, deleting the QoS flow locally; S102, marking a status of the QoS flow as being deleted and not synchronized; and S103, transmitting a protocol data unit, PDU, session modification request to synchronize the status of the QoS flow.

According to embodiments of the present disclosure, if a terminal device, such as UE, has locally deleted a QoS Flow, the UE may send an explicit Non-Access Stratum, NAS, message (such as the PDU session modification request) to request the network side to delete the QoS Flow, so as to achieve the synchronization.

It should be understood the numbers, such as S101, S102, S103, are only used to simplify the illustration, but not intended to limit the sequence of the steps in this method. For example, step S102 may be performed before the step S101, or just simultaneously.

As shown in FIG. 2, the step S101 may comprise substeps S1011, deleting a dedicated EPS bearer locally when the terminal device is in the EPS, and S1012, moving from the EPS to 5GS. Or, the step S101 may comprises substeps S1013, deleting the QoS flow locally when the terminal device is in 5GS.

In embodiments of the present disclosure, in S1011, the QoS flow is deleted due to a deletion of a dedicated evolved packet system, EPS, bearer. The QoS flow is mapped from the dedicated EPS bearer when preparing for an interworking procedure of the terminal device from an EPS to a 5th generation system, 5GS. Then, in S1012, the terminal device moves from EPS to 5GS. The PDU session modification request includes: a request to clean up the QoS flow.

According to embodiments of the present disclosure, when the status of the QoS Flow is changed by the terminal device in a scenario of being moved from EPS to 5GS, the status of the QoS Flow can still be synchronized.

In embodiments of the present disclosure, the PDU session modification request is transmitted when the terminal device changes from a CM-IDLE status to a CM-CONNECTED status, wherein CM refers to connection management.

According to embodiments of the present disclosure, the synchronization of the status of the QoS flow may be made at the next time the UE changes its state from CM-IDLE to CM-CONNECTED.

In embodiments of the present disclosure, the QoS flow is a QoS flow not associated to a default QoS rule.

Further, as a second specific embodiment, a terminal device, such as a UE, stays in 5GS, either connected to 5GS initially, or moved from the EPS to the 5GS. Then, in S1013, the UE may locally delete a QoS flow, but not notify the network side. Then, the network still has the QoS flow. This QoS flow is unsynchronized. When the communication between the UE and the network side starts, downlink, DL, packet will be able to be sent from the network side to the UE on the unsynchronized QoS Flow. Uplink, UL, packet will probably be sent via other synched QoS flow, such as a QoS Flow associated with a default QoS rule.

In such a scenario, as the same as in the first embodiment, the possible issue is that differentiation of UL packet forwarding treatment cannot be achieved (assume the UE does not drop the DL packet received from the network on the unsynchronized QoS Flow), or the UE will just drop the DL packet on the unsynchronized QoS Flow.

The method shown in FIG. 1 is still applicable. And, the QoS flow is deleted when the terminal device is in a 5GS. The PDU session modification request includes: a request to clean up the QoS flow.

In embodiments of the present disclosure, the QoS flow is a QoS flow not associated to a default QoS rule.

Therefore, in the above embodiments, if a UE has locally deleted a QoS Flow in the 5GS, which is not associated with the default QoS rule, at the next time the UE contacts the network (for example, before a transmission of an UL packet), the UE sends an explicit Non-Access Stratum, NAS, message (such as the PDU session modification request) to request the network side to delete the QoS Flow, so as to achieve the synchronization.

This is, according to embodiments of the present disclosure, when the status of the QoS Flow is changed by the terminal device in a scenario of being in 5GS, the status of the QoS Flow can still be synchronized.

As a third specific embodiment, a terminal device, such as a UE, moves from the EPS to the 5GS. The network side deletes a dedicated EPS bearer in the EPS, and not notify the UE. For example, a mobility management entity, MME, or a packet data network gateway, PGW may initiate the deletion of the dedicated EPS bearer.

Therefore, after a PDU session between the UE and the network is established in 5GS, the UE still has the QoS Flow associated to the deleted dedicated EPS bearer. This QoS Flow(s) is unsynchronized. When the communication between the UE and the network side starts in 5GS, DL packet will be transferred using other synchronized QoS flows, such as the QoS Flow associated with the default QoS rule. UL packets may be transferred using that unsynchronized QoS Flow and it may get dropped by NG-RAN because NG-RAN cannot match it to any known QoS profile. NG-RAN refers to next generation-radio access network.

In such a scenario, the possible issue is that UL packets on unsynchronized QoS Flow may get dropped, and thus a corresponding service may be interrupted.

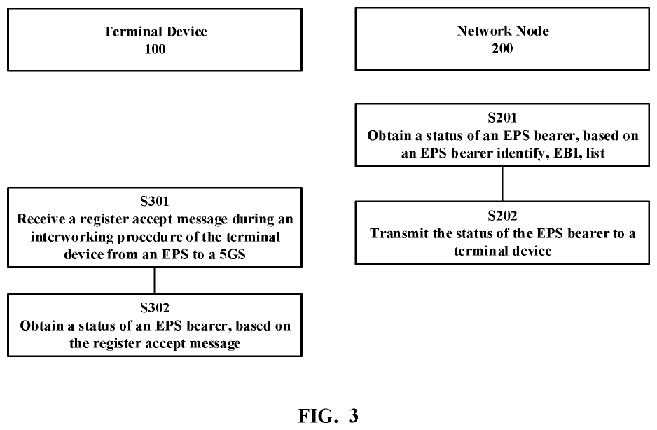

FIG. 3 is an exemplary flow chart showing other methods according to embodiments of the present disclosure.

As shown in FIG. 3, a method is performed at a network node 200 for a synchronization of a status of a bearer in a communication system. The method comprises: S201, obtaining a status of an EPS bearer, based on an EPS bearer identify, EBI, list; S202, transmitting the status of the EPS bearer to a terminal device.

In embodiments of the present disclosure, the EPS bearer comprises: a default EPS bearer or a dedicated EPS bearer. The status of the EPS bearer is transmitted in a register accept message during an interworking procedure of the terminal device from an EPS to a 5GS.

In embodiments of the present disclosure, the method further comprises: obtaining the EBI list from one or more system management functions, SMFs.

In embodiments of the present disclosure, the status of the EPS bearer is related to whether being active, or inactive.

In embodiments of the present disclosure, a deletion of the EPS bearer is initiated by a mobility management entity, MME, or packet data network gateway, PGW, and not synchronized with the terminal device.

In embodiments of the present disclosure, the network node is an access and mobility management function, AMF.

Accordingly, as shown in FIG. 3, a method is performed at a terminal device, for a synchronization of a status of a bearer in a communication system. The method comprises: S301, receiving a register accept message during an interworking procedure of the terminal device from an EPS to a 5GS; S302, obtaining a status of an EPS bearer, based on the register accept message. The status of the EPS bearer is included in the register accept message by a network node, based on an EPS bearer identify, EBI, list.

In embodiments of the present disclosure, the status of the EPS bearer is related to whether being active or inactive.

According to the above embodiments, if a network side has deleted an EPS bearer, and does not inform the UE, it's proposed that the AMF includes in Register Accept a new EPS Bearer Status IE based on the EBI list currently provided by the SMF(s), so as to update the status of the QoS flows mapped from the EPS bearer.

This is, according to embodiments of the present disclosure, when the status of the QoS Flow is changed by the network side in a scenario that the terminal device moves from EPS to 5GS, the status of the QoS Flow can still be synchronized.

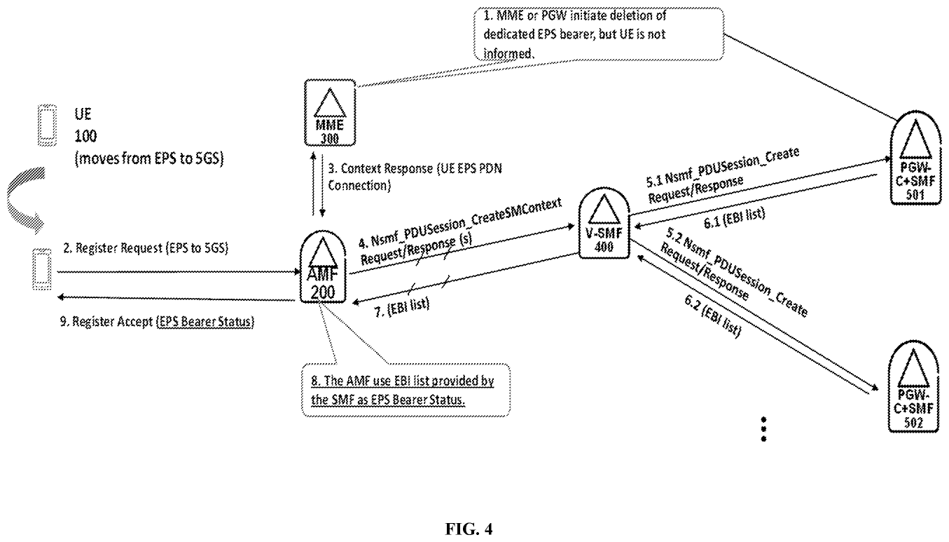

FIG. 4 is an exemplary diagram showing an implementation of methods shown in FIG. 3 in a communication system.

As shown in FIG. 4, the terminal device (UE) 100 moves from the EPS to 5GS. During or before this movement, in step 1, a MME 300, or a PGW (such as PGW-C+SMF 501 or PGW-C+SMF 502) initiate deletion of dedicated EPS bearer, but UE is not informed. PGW-C+SMF refers to packet data network gateway-control plane+system management function.

In step 2, UE 100 sends a register request to a network node (AMF) 200. In step 3, AMF 200 obtains context response (about UE EPS PDN connection) from MME 300. In step 4 and step 7, AMF 200 sends “Nsmf_PDUSession_CreateSMContext” request message to visiting-system management function, V-SMF 400 and receives response(s). In step 5.1 and step 6.1, the V-SMF 400 sends “Nsmf_PDUSession_Create” Request to a PGW-C+SMF 501, and receives a response. Step 5.2 and step 6.2 are the same as step 5.1 and step 6.1, and only used to show that the V-SMF 400 may be connected with more than one PGW-C+SMF. In step 8, the AMF 200 use EBI list provided by the SMF to obtain EPS Bearer Status. Then in step 9, the AMF 200 sends a response message, such as register accept message, including the EPS bearer Status.

EBI list may include information about an EPS bearer identifier.

In this embodiments, since the EPS bearer in EPS will be mapped to QoS flow in the 5GS, the synchronization of EPS bearer Status equals to the synchronization of status of QoS flow.

EPS Bearer Status information element, IE, may be used to indicate the EPS bearer Status to indicate whether an EPS bearer is active or not. A value of “1” indicates active, and a value of “0” indicating inactive.

According to embodiments of the present disclosure, when the status of the QoS Flow is changed by the network side in a scenario of that the terminal device moves from EPS to 5GS, the status of the QoS Flow can still be synchronized.

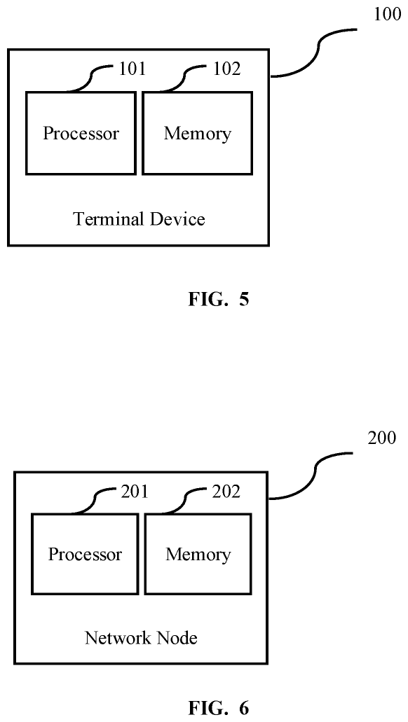

FIG. 5 is a block schematic showing an exemplary terminal device according to embodiments of the present disclosure.

As shown in FIG. 5 the terminal device 100 comprises: a processor 101; and a memory 102, containing instructions executable by the processor 101. The terminal device is operative to: delete (S101) a quality of service, QoS, flow locally; mark (S102) a status of the QoS flow as being deleted and not synchronized; and transmit (S103) a protocol data unit, PDU, session modification request to synchronize the status of the QoS, flow.

In embodiments of the present disclosure, the terminal device is operative to any of the methods above mentioned.

FIG. 6 is a block schematic showing an exemplary network node according to embodiments of the present disclosure.

As shown in FIG. 6, the network node 200 comprises: a processor 201; and a memory 202, containing instructions executable by the processor 201. The network node 200 is operative to: obtain (S201) a status of an EPS bearer, based on an EPS bearer identify, EBI, list; transmit (S202) the status of the EPS bearer to a terminal device.

In embodiments of the present disclosure, the network node is operative to any of the methods above mentioned.

Accordingly, the terminal device 100 is operative to: receive (S301) a register accept message during an interworking procedure of the terminal device from an EPS to a 5GS; obtain (S302) a status of an EPS bearer, based on the register accept message. The status of the EPS bearer is included in the register accept message by a network node, based on an EPS bearer identify, EBI, list.

In embodiments of the present disclosure, the terminal device is operative to any of the methods above mentioned.

Processor 101, 201 may be configured to implement execute machine instructions stored as machine-readable computer programs in the memory 102, 202, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above.

Embodiments of the present disclosure provides a virtual apparatus for the terminal device, including: deleting unit, configured to delete (S101) a quality of service, QoS, flow locally; marking unit, configured to mark (S102) a status of the QoS flow as being deleted and not synchronized; and transmitting unit, configured to transmit (S103) a protocol data unit, PDU, session modification request to synchronize the status of the QoS, flow.

Embodiments of the present disclosure provides a virtual apparatus for the network node, including: obtaining unit, configured to obtain (S201) a status of an EPS bearer, based on an EPS bearer identify, EBI, list; transmitting unit, configured to transmit (S202) the status of the EPS bearer to a terminal device.

Accordingly, embodiments of the present disclosure further provides a virtual apparatus for the terminal device, including: a receiving unit, configured to receive (S301) a register accept message during an interworking procedure of the terminal device from an EPS to a 5GS; an obtaining unit, configured to obtain (S302) a status of an EPS bearer, based on the register accept message. The status of the EPS bearer is included in the register accept message by a network node, based on an EPS bearer identify, EBI, list.

With virtual apparatus, the access management node and the session management node may not need fixed processor or memory, any computing resource and storage resource may be arranged from at least one node device in the network. The introduction of virtualization technology and network computing technology may improve the usage efficiency of the network resources and the flexibility of the network.

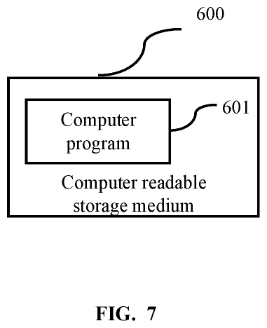

FIG. 7 is schematic showing computer readable storage medium 600 in accordance with some embodiments.

As shown in FIG. 7, the computer readable storage medium 600 has a computer program 601 stored thereon, wherein the computer program is executable by a device to cause the device to carry out any of the methods above mentioned, such as methods shown in FIGS. 1, 2, 3, 4.

Computer readable storage medium 600 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processor 101, 201. Computer readable storage medium 600 may store any suitable instructions, data or information, including a computer program, software, an application including one or more of logic, rules, code, tables, etc. and/or other instructions capable of being executed by processor 201, 301. Computer readable storage medium 600 may be used to store any calculations made by processor 101, 201 and/or any data received via external interface. In some embodiments, processor 101, 201 and computer readable storage medium 900 may be considered to be integrated.

According to embodiments of the present disclosure, when the status of the QoS Flow is changed by one of the terminal device or the network side in some scenarios, the status of the QoS Flow can still be synchronized.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1.-21. (canceled)

22. A method, performed at a terminal device, for a synchronization of a status of a quality of service (QoS) flow in a communication system, the method comprising:
deleting the QoS flow locally;
marking a status of the QoS flow as being deleted and not synchronized; and
transmitting a protocol data unit (PDU) session modification request to synchronize the status of the QoS flow.

23. The method according to claim 22,
wherein the QoS flow is deleted due to a deletion of a dedicated evolved packet system (EPS) bearer;
wherein the QoS flow is mapped from the dedicated EPS bearer when preparing for an interworking procedure of the terminal device from an EPS to a 5th generation system (5GS); and
wherein the PDU session modification request includes a request to clean up the QoS flow.

24. The method according to claim 23, wherein the PDU session modification request is transmitted when the terminal device changes from a CM-IDLE status to a CM-CONNECTED status, wherein CM refers to connection management.

25. The method according to claim 22, wherein the QoS flow is a QoS flow not associated with a default QoS rule.

26. The method according to claim 22,
wherein the QoS flow is deleted when the terminal device is in a 5GS; and
wherein the PDU session modification request includes a request to clean up the QoS flow.

27. The method according to claim 26, wherein the QoS flow is a QoS flow not associated to a default QoS rule.

28. A method, performed at a network node, for a synchronization of a status of a bearer in a communication system, the method comprising:
obtaining a status of an evolved packet system (EPS) bearer based on an EPS bearer identify (EBI) list; and
transmitting the status of the EPS bearer to a terminal device.

29. The method according to claim 28,
wherein the EPS bearer comprises: a default EPS bearer or a dedicated EPS bearer; and
wherein the status of the EPS bearer is transmitted in a register accept message during an interworking procedure of the terminal device from an EPS to a 5th generation system (5GS).

30. The method according to claim 28, further comprising obtaining the EBI list from one or more system management functions (SMFs).

31. The method according to claim 30, wherein the status of the EPS bearer is related to whether the EPS bearer is active or inactive.

32. The method according to claim 28, wherein a deletion of the EPS bearer is initiated by a mobility management entity (MME) or packet data network gateway (PGW), and not synchronized with the terminal device.

33. The method according to claim 28, wherein the network node is an access and mobility management function (AMF).

34. A method, performed at a terminal device, for a synchronization of a status of a bearer in a communication system, the method comprising:
receiving a register accept message during an interworking procedure of the terminal device from an evolved packet system (EPS) to a 5th generation system (5GS); and
obtaining a status of an EPS bearer based on the register accept message, wherein the status of the EPS bearer is included in the register accept message by a network node based on an EPS bearer identify (EBI) list.

35. The method according to claim 34, wherein the status of the EPS bearer is related to whether the EPS bearer is active or inactive.

36. A terminal device, comprising:
a processor; and
a memory storing instructions, which when executed by the processor, cause the terminal device to:
delete a quality of service (QoS) flow locally;
mark a status of the QoS flow as being deleted and not synchronized; and
transmit a protocol data unit (PDU) session modification request to synchronize the status of the QoS flow.

37. A network node, comprising:
a processor; and
a memory storing instructions, which when executed by the processor, cause the network node to:
obtain a status of an evolved packet system (EPS) bearer based on an EPS bearer identify (EBI) list; and
transmit the status of the EPS bearer to a terminal device.

38. A terminal device, comprising:
a processor; and
a memory storing instructions, which when executed by the processor, cause the terminal device to:
receive a register accept message during an interworking procedure of the terminal device from an evolved packet system (EPS) to a 5th generation system (5GS); and
obtain a status of an EPS bearer based on the register accept message, wherein the status of the EPS bearer is included in the register accept message by a network node, based on an EPS bearer identify (EBI) list.

39. The terminal device according to claim 38, wherein the status of the EPS bearer is related to whether the EPS bearer is active or inactive.
